(19) United States
(12) Patent Application Publication
(10) Pub. No.: US 2026/0112066 A1
(43) Pub. Date: Apr. 23, 2026

(54) CONNECTIVITY REGULARIZATION FOR TRIANGULAR MESHES

(71) Applicant: GOOGLE LLC, Mountain View, CA (US)

(72) Inventors: Igor Vytyaz, Folsom, CA (US); Ondrej Stava, San Jose, CA (US)

(21) Appl. No.: 19/360,750

(22) Filed: Oct. 16, 2025

Related U.S. Application Data
(60) Provisional application No. 63/708,475, filed on Oct. 17, 2024.

(51) Int. Cl. G06T 9/00; G06T 7/13; G06T 7/60; G06T 17/20

(52) U.S. Cl. CPC G06T 9/001; G06T 7/13; G06T 7/60; G06T 17/205

(57) ABSTRACT

A method including determining a mesh includes irregular connectivity, in response to determining the mesh includes irregular connectivity regularize the mesh and generate regularization data, and compressing the regularized mesh and the regularization data.

### CROSS-REFERENCE TO RELATED APPLICATION

This application claims priority to U.S. Provisional Patent Application No. 63/708,475, filed on Oct. 17, 2024, entitled “CONNECTIVITY REGULARIZATION FOR TRIANGULAR MESHES”, the disclosure of which is incorporated by reference herein in its entirety.

### BACKGROUND

Three-dimensional (3D) mesh data is fundamental to many applications, including computer graphics, virtual reality, and scientific visualization. A common representation for 3D objects is a triangular mesh, which consists of vertices, edges, and triangular faces that define the object's surface. These meshes are often generated from quad-based models used in content creation tools. During the export process, each quadrilateral (quad) is split into two triangles. This triangulation can result in connectivity where the diagonal edges created by splitting the quads are not aligned consistently across the mesh.

### SUMMARY

Some implementations describe a method for making 3D models smaller and faster to transmit by temporarily reorganizing their internal structure. An encoder can reorganize the model's disordered triangle patterns into a regular grid, which can be more compressible. The encoder can save a listing of the changes it made. This compressed, regularized model and the listing can be sent to another device. A decoder on the device then unpacks the model and uses the listing to reverse the changes, thus restoring the original 3D model. A benefit is faster delivery and lower data usage without any loss of quality.

For example, a user of a device installs a graphically-intensive game from an app store. The app store can provide the game files, where the 3D models have been compressed using this technology. The download is significantly smaller, saving data and time. When the user first launches the game, the game engine on the device decompresses the assets using this technology, restoring the high-quality models for gameplay.

For example, some implementations describe an improvement for the compression of triangular meshes. The system first analyzes an input mesh to identify irregular connectivity, which often results from converting quad-based models into triangles. This irregular connectivity is then modified, or regularized, by flipping diagonal edges to create more uniform patterns. This process generates a regularized mesh and corresponding regularization data, which stores the information about the edge flips that were performed. The regularized mesh, having more predictable patterns, can then be compressed more efficiently.

During decompression, the system uses both the compressed mesh data and the regularization data. The compressed mesh is first decompressed to restore its regularized form. Then, the regularization data is applied to reverse the edge flips that were made during the encoding process. This step restores the original irregular connectivity of the mesh. The final output is a reconstructed mesh that is a lossless representation of the original input mesh, having been stored and transmitted more efficiently due to the intermediate regularization step.

In a general aspect, a device, a system, a non-transitory computer-readable medium (having stored thereon computer executable program code which can be executed on a computer system), and/or a method can perform a process with a method including determining a mesh includes irregular connectivity, in response to determining the mesh includes irregular connectivity regularize the mesh and generate regularization data, and compressing the regularized mesh and the regularization data.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations.

FIG. 1 illustrates a mesh encoder/decoder system according to at least one example implementation.

FIG. 2A illustrates a portion of a mesh with irregular connectivity according to at least one example implementation.

FIG. 2B illustrates the portion of the mesh with regular connectivity according to at least one example implementation.

FIG. 3A illustrates a portion of a mesh with regular connectivity according to at least one example implementation.

FIG. 3B illustrates the portion of the mesh with irregular connectivity according to at least one example implementation.

FIG. 4 illustrates a portion of a mesh with flipped edges represented as bits at each corner according to at least one example implementation.

FIG. 5 illustrates the portion of the mesh with a subset of bits representing flipped edges at each corner according to at least one example implementation.

FIG. 6 illustrates the portion of the mesh with edge and corner identification according to at least one example implementation.

FIG. 7 illustrates a method for compressing a mesh according to at least one example implementation.

FIG. 8 illustrates a method for decompressing a compressed mesh according to at least one example implementation.

It should be noted that these Figures are intended to illustrate the general characteristics of methods, and/or structures utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

Sending large files over the internet, like the detailed 3D models used in modern video games and virtual reality, can be slow and use a lot of data. A key reason these files are so large is that the underlying structure, a “mesh” of tiny triangles, is often irregular and chaotic. Think of it like trying to pack a box with a jumble of oddly shaped objects versus neatly stacked blocks; the stacked blocks take up less space. The technology described here provides a method to temporarily “stack the blocks.” It takes a 3D mesh with an irregular structure and algorithmically rearranges its connections to be more uniform and grid-like. This regularized mesh is far more compressible. To ensure no detail is lost, the system also saves a small map of the changes it made. During decompression, it reverses the process, using the map to restore the mesh to its original, irregular form perfectly. The result is a lossless compression process that significantly reduces file size, making it faster and cheaper to store.

Content creation tools commonly work with quad meshes and export the quad meshes as triangular meshes for transmission and rendering (e.g., in glTF file format). The triangulation process can split a quad into pairs of triangles. The resultant triangular mesh often includes irregular connectivity with vertex degrees ranging from four to eight. Irregular connectivity can include diagonal edges introduced by triangulation not being aligned with each other.

Irregular connectivity poses a significant challenge for data compression. Mesh compression algorithms aim to reduce the file size of 3D models to facilitate efficient storage and transmission. These algorithms perform better on data with predictable, repeating patterns. Meshes with regular connectivity, where vertices are consistently connected and patterns are uniform, exhibit lower entropy and can be compressed more effectively. In contrast, the unpredictable nature of irregular connectivity reduces the efficiency of prediction models used in compression, leading to larger file sizes and increased bandwidth requirements. Accordingly, at least one technical problem can be that meshes (or mesh portions) including irregular connectivity may not compress as well as meshes (or mesh portions) including regular connectivity.

Therefore, a method for transforming irregular mesh connectivity into a more regular form before compression is needed to improve overall compression performance. At least one technical solution to the technical problem can include modifying mesh connectivity of meshes including irregular connectivity prior to compressing the mesh. Alternatively, or in addition, at least one technical solution to the technical problem can include modifying mesh connectivity of meshes including irregular connectivity while compressing the mesh. The technical solution can include generating information and/or data used to restore the original connectivity after decompressing the mesh. At least one technical effect of the technical solution can be more efficient compression (e.g., generating smaller files) of meshes (or mesh portions) including irregular connectivity.

At least one technical benefit to the technical solution can be leveraging the fact that compression algorithms perform more efficiently on data with predictable, repeating patterns. The regularized mesh exhibits lower entropy because its traversal encounters consistent connectivity structures and similar prediction neighborhoods for vertex attributes. This uniformity results in smaller variability in the data, which allows prediction models within the compression algorithm to operate more effectively. Consequently, the regularized mesh can be compressed into a smaller file size than the original, irregular mesh, leading to significant reductions in storage space and bandwidth required for transmission. For example, an experiment using a standard quad mesh dataset yielded overall size reduction of up to 13.9% and 4.5% on average using connectivity regularization. The experiments accounted for the overhead of encoding data necessary to reconstruct the original connectivity.

Regularizing a mesh can include performing a set of algorithmic, topological operations, such as identifying and flipping diagonal edges, that modify the mesh's connectivity. The process can transform a mesh with inconsistent or unpredictable connectivity into one that is dominated by uniform, repeating patterns, thereby reducing its entropy and making it more compressible.

In some implementations, regularizing a mesh can include functionally optimizing its topological structure for data compression. This is achieved by modifying the connectivity, for example by flipping diagonal edges, to create a more uniform and predictable pattern that can be more efficiently encoded by a compression algorithm. Regularizing a mesh can include modifying its connectivity by flipping diagonal edges to produce a more uniform pattern, thereby making the mesh more compressible.

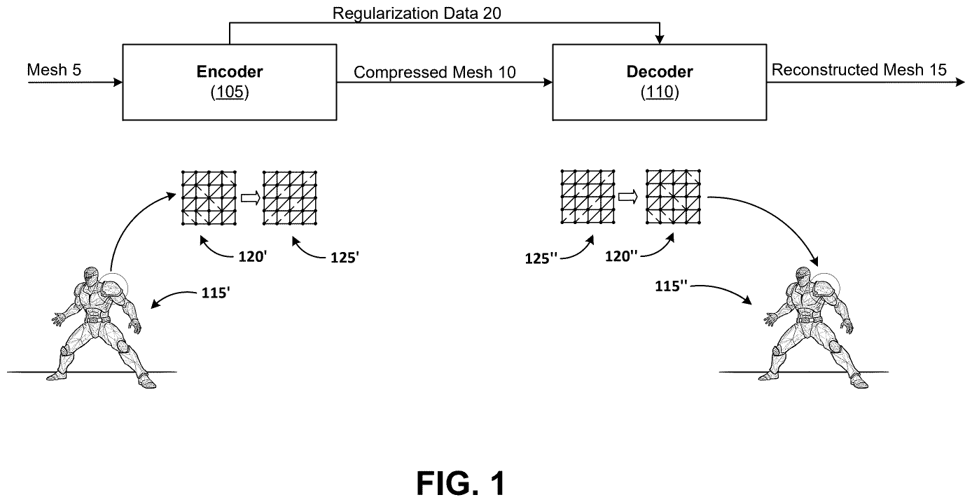

FIG. 1 illustrates a mesh encoder/decoder system according to at least one example implementation. As shown in FIG. 1, the mesh encoder/decoder system can include an encoder 105 and a decoder 110. The encoder 105 can receive a mesh 5 and generate a compressed mesh 10 and regularization data 20. The decoder 110 can receive the compressed mesh 10 and the regularization data 20 and generate a reconstructed mesh 15.

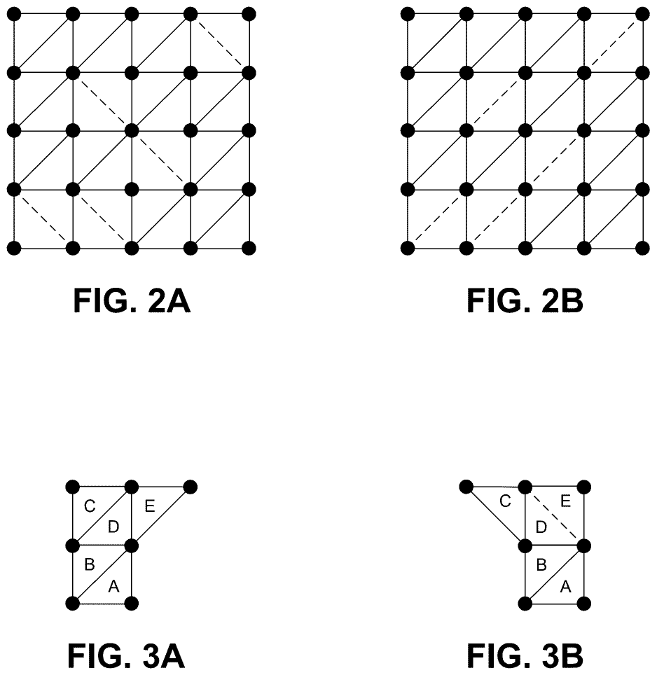

In some implementations, the mesh 5 can be a quad mesh and the encoder 105 can be configured to perform a triangulation process to split a quad of the mesh 5 into pairs of triangles. In some implementations, the mesh 5 can be a triangularized quad mesh. In some implementations, the mesh 5 can be a triangular mesh. In some implementations, the mesh 5 can be a portion of a larger mesh. In some implementation, mesh 5 can include irregular connectivity. Referring to FIG. 2A, illustrated is a quad mesh after a triangulation process. In FIG. 2A, the dashed edges can illustrate irregular connectivity.

FIG. 1 illustrates a system for improving the compression and decompression of a 3D mesh. The system includes an encoder 105 and a decoder 110. The encoder 105 receives an input mesh 5, which may have irregular connectivity, and processes it to produce two outputs: a compressed mesh 10 and regularization data 20. The decoder 110 receives both the compressed mesh 10 and the regularization data 20. It uses this information to generate a reconstructed mesh 15 that is a lossless representation of the original input mesh 5. This process allows for more efficient storage and transmission of the mesh data by leveraging a more compressible, regularized intermediate format.

The input mesh 5 can be a 3D triangular mesh that serves as the initial data for the compression process. In many content creation pipelines, 3D models are built using quadrilaterals (quads). When these models are exported for rendering or transmission, each quad is typically split into two triangles. This triangulation process can introduce diagonal edges that are not consistently aligned across the mesh, a condition referred to as irregular connectivity. The input mesh 5 can be any triangular mesh, but the system is particularly effective for those that exhibit this kind of irregular connectivity resulting from quad triangulation. For example, an app store can include game files, where a 3D model can represent content including a game character 115′.

For example, a portion of a mesh representing a flat grid, originally composed of quads, might be triangulated such that the diagonal edges within each original quad are oriented randomly. This randomness disrupts the repeating patterns that compression algorithms rely on for efficiency. For example, the mesh portion 120′ can include diagonals that are oriented randomly. This can be seen in more detail in FIG. 2A which provides a visual example of such a mesh portion with irregular connectivity, where the diagonal edges (highlighted for clarity in some examples) do not follow a uniform pattern. The input mesh 5 can represent an entire 3D object or just a specific portion of a larger mesh that is being processed.

The compressed mesh 10 can be the output of the encoder 105 after processing the input mesh 5. The compressed mesh 10 can represent the geometric and attribute information of the mesh in a regularized and compressed format. The regularization step, which precedes compression, modifies the mesh connectivity to create more uniform patterns, making the data more predictable. The encoder 105 then applies a compression algorithm to this regularized mesh, resulting in the compressed mesh 10. This data is smaller in size compared to what would have been achieved by compressing the original, irregular mesh directly.

For example, after the encoder 105 regularizes (e.g., mesh portion 125′) the mesh shown in FIG. 2A to the form shown in FIG. 2B, encoder 105 then compresses this regularized version to create the compressed mesh 10. This data contains all the necessary information, such as vertex positions and connectivity for the regularized grid, but in an efficient, compressed form. The compressed mesh 10 is designed to be paired with the regularization data 20, as both are required by the decoder 110 to losslessly reconstruct the original input mesh 5.

A regularized mesh can refer to a triangular mesh that has been structurally modified from an original mesh to exhibit a more uniform and predictable connectivity pattern. Specifically, in the context of a mesh originating from quadrilaterals (quads), a regularized mesh is one where the diagonal edges that partition the quads into triangles follow a consistent orientation across a region of the mesh. For example, as shown in FIG. 2B, all diagonal edges may be oriented from the bottom-left vertex to the top-right vertex of their respective conceptual quads. This uniformity results in a topology where a majority of the interior vertices have a degree of six (i.e., they are connected to six other vertices), which is characteristic of a regular grid.

The regularization data 20 is a separate output from the encoder 105 that records the modifications made to the original input mesh 5 connectivity. During the regularization process, the encoder identifies diagonal edges that create irregular patterns and flips them to establish a more uniform connectivity structure. Regularization data 20 can include information about which specific edges were flipped. This data is used by decoder 110 to reverse the process and reconstruct the original input mesh 5, such that the compression and decompression cycle can be (or can be substantially) lossless.

The state of being regularized can be achieved by an algorithmic process, such as the example connectivity regularization algorithm described below. This process identifies local quad structures and propagates a chosen diagonal orientation, flipping diagonals that deviate from this established pattern. Therefore, a regularized mesh is not defined by an absolute global perfection but rather by the outcome of a process that systematically reduces connectivity entropy. The resulting mesh is regularized in that its structure is dominated by predictable, repeating topological patterns that are highly amenable to compression algorithms, distinguishing it from an irregular mesh where such patterns are inconsistent or absent.

For example, if the encoder 105 flips five diagonal edges in the mesh shown in FIG. 2A to produce the regularized version in FIG. 2B, the regularization data 20 would contain information identifying those five specific edges. This could be stored as a list of edge indices or as a bitmask corresponding to the quads in the mesh, where a ‘1’ indicates a flipped diagonal and a ‘0’ indicates no change. This data can be small (e.g., number of bits) compared to the overall mesh data but is critical for restoring the original connectivity during decompression.

The reconstructed mesh 15 is the final output of the decoder 110, representing a lossless (or substantially lossless) restoration of the original input mesh 5. The decoder 110 first decompresses the compressed mesh 10 to obtain the regularized mesh (e.g., mesh portion 125″). Decoder 110 then applies the regularization data 20 to reverse the edge flips that were performed by the encoder 105. This step reintroduces the original irregular connectivity (e.g., mesh portion 120″), ensuring that the reconstructed mesh 15 (e.g., as game character 115″) is identical in terms of geometry, attributes, and connectivity to the initial input mesh 5.

Original irregular connectivity can refer to the initial topological state of a triangular mesh, prior to any regularization, that is characterized by inconsistent or unpredictable patterns in how its vertices are connected. This condition is most common in meshes derived from the triangulation of quadrilateral (quad) grids, where the diagonal edge chosen to split each quad into two triangles does not follow a uniform rule across the mesh. As illustrated in FIG. 2A, this results in a mesh where the orientation of diagonal edges can appear random or haphazard, breaking the predictable grid-like structure that is optimal for compression algorithms. The term original can signify that this is the connectivity of the input mesh 5 as presented to the encoder, and irregular can denote the lack of a consistent, repeating pattern in the local topology.

This irregularity is quantitatively reflected in several ways: a higher variability in vertex degrees (e.g., vertices connected to four, five, seven, or eight neighbors, rather than the consistent six of a regular grid), and a higher entropy when traversing the mesh's connectivity graph. From a predictive compression standpoint, this means that the local neighborhood of a vertex cannot be reliably predicted from its neighbors, reducing the efficiency of compression. The system is designed to identify this original irregular connectivity, transform it into a regularized state for efficient compression, and then losslessly restore it during decompression, ensuring the reconstructed mesh is identical to the original.

For example, after decompressing the regularized mesh from FIG. 2B, the decoder 110 uses the regularization data 20, which identifies the three edges that were flipped, to reverse those specific flips. This action transforms the mesh back into the irregular form shown in FIG. 2A. The resulting reconstructed mesh 15 is a perfect copy of the original input mesh 5, demonstrating that the entire compression and decompression process is lossless despite the intermediate structural changes.

The encoder 105 can be configured to prepare and compress the input mesh 5. Encoder 105 can transform the input mesh 5 into a format that is more efficient for storage and transmission. To achieve this, the encoder 105 first processes the mesh to identify and modify its connectivity. Encoder 105 then applies a compression algorithm to the resulting mesh to produce the compressed mesh 10.

In some implementations, the encoder 105 can be configured to perform a regularization process on mesh 5. The regularization process can include identifying illustrate irregular connectivity within mesh 5. Identifying irregular connectivity within mesh 5 can include identifying edges (e.g., the dashed edges of FIG. 2A) having a direction that is inconsistent with surrounding edges and/or other edges in the mesh. The regularization process can include generating regularization data 20 based on the irregular connectivity identified irregular connectivity. In other words, regularization data 20 can include information associated with the irregular connectivity (e.g., the dashed edges of FIG. 2A). In other words, regularization data 20 can include information associated with edges (e.g., the dashed edges of FIG. 2A) having a direction that is inconsistent with surrounding edges and/or other edges in the mesh.

The regularization process can include modifying the mesh connectivity of mesh 5 remove irregular connectivity. Referring to FIG. 2B, illustrated is a quad mesh after a triangulation process and after a regularization process. In FIG. 2B, the dashed edges can illustrate connectivity within the mesh that has been modified to remove irregular connectivity. In FIG. 2B the edges (e.g., the dashed edges) have been modified to have a direction that is consistent with surrounding edges. The encoder 105 can be configured to compress the regularized mesh 5 to generate the compressed mesh 10. In some implementations, regularization data 20 and compressed mesh 10 can be communicated as, for example, streaming data to decoder 110. In some implementations, regularization data 20 and compressed mesh 10 can be stored in a memory and retrieved by decoder 110 at some time in the future.

For example, upon receiving the input mesh 5, which may have irregular connectivity as shown in FIG. 2A, the encoder 105 analyzes the mesh structure. After this analysis, it compresses the mesh's geometric and attribute data, resulting in the compressed mesh 10. This output contains the mesh data in a compact form, which, when combined with the regularization data 20, allows the decoder 110 to perfectly reconstruct the original mesh. Encoder 105 can ensure that both outputs are generated and synchronized for the decompression process.

The decoder 110 receives the compressed mesh 10 and processes it to produce the final reconstructed mesh 15. The decoder 110 can be configured to reverse the compression applied by the encoder 105. This involves a decompression algorithm that restores the mesh's geometric and attribute data, such as vertex positions and connectivity information, from its compressed state back into a usable format. The decoder ensures that the information contained within the compressed mesh 10 is accurately translated into a complete and valid 3D mesh structure.

In some implementations, decoder 110 can receive the compressed mesh 10 and the regularization data 20 and generate a reconstructed mesh 15. The decoder 110 can be configured to decompress the compressed mesh 10. The decoder 110 can be configured to modify the decompressed mesh based on the regularization data 20. After modifying the decompressed mesh, the decompressed mesh can include the same or substantially the same irregular connectivity as mesh 5. In some implementations, the decoder 110 can output the decompressed mesh including the same or substantially the same irregular connectivity as mesh 5 as reconstructed mesh 15. Accordingly, reconstructed mesh 15 can be a reconstructed representation of mesh 5. In other words, reconstructed mesh 15 can be substantially the same as mesh 5 including the irregular connectivity.

For example, if the compressed mesh 10 represents a predictable grid structure, the decoder 110 first decompresses this data to recreate that grid. This step restores the vertex positions and the simplified, uniform connectivity of the intermediate mesh format. At this stage, the output of the decompressor is a regularized mesh, as shown in FIG. 2B. This mesh is geometrically complete but does not yet have the original connectivity of the input mesh 5. The decoder then proceeds to use additional data to fully reconstruct the original mesh.

After decompression, decoder 110 can apply the information from the regularization data 20 to reverse the connectivity changes made by encoder 105. This step involves performing the inverse edge flips on the regularized mesh, effectively reintroducing the original irregular connectivity. For example, if the regularization data 20 indicates that five specific edges were flipped during encoding (e.g., to transform the mesh in FIG. 2A to that in FIG. 2B), the decoder flips those same five edges back. This restoration process ensures that the final output, the reconstructed mesh 15, is a bit-for-bit identical, lossless copy of the original input mesh 5.

An inverse edge flip can be the operation performed by the decoder to reverse a corresponding edge flip that occurred during the encoding process. An edge flip is a common topological operation in mesh processing where a single edge shared by two adjacent triangles is removed and replaced by a new edge connecting the two previously unconnected vertices of the quadrilateral formed by the two triangles. This effectively changes which pair of vertices in the quadrilateral is connected by a diagonal. The inverse of this operation is simply performing the same edge flip operation again on the same edge, which restores the original connectivity. For example, if an edge connecting vertices A and C was flipped to connect vertices B and D, an inverse edge flip on the new B-D edge would remove it and re-establish the A-C edge.

The inverse edge flip can be the mechanism for restoring the original irregular connectivity of the mesh. The regularization data 20 can include a set of instructions, effectively a list of which edges were flipped by the encoder. The decoder, after decompressing the regularized mesh, reads this data and applies an inverse edge flip to each identified edge. As described in claim 18, this process systematically undoes the modifications made during regularization, reintroducing the original irregularities and ensuring that the final reconstructed mesh 15 is a lossless, bit-for-bit identical copy of the original input mesh 5.

Connectivity regularization leads to improved compression of connectivity, positions, and other mesh attributes. During the encoding process, the codec typically traverses mesh vertices in a sequence and encodes vertex connectivity, position, and other attributes. The traversal of meshes with regular connectivity encounters repeated connectivity structures and similar attribute prediction neighborhoods, resulting in smaller variability, lower entropy, and better compression.

FIG. 2A illustrates a portion of a mesh with irregular connectivity according to at least one example implementation. FIG. 2A illustrates an example of a triangular mesh with irregular connectivity. FIG. 2B illustrates a regularized version of the triangular mesh shown in FIG. 2A. For example, FIG. 2A illustrates a portion of a mesh with irregular connectivity. FIG. 2A shows a 5×5 grid of vertices (alternatively, a 4×4 grid of triangulated quads) connected to form a series of quadrilaterals, which have been triangulated. The solid and dashed lines represent the edges of these triangles. Within this structure, some diagonal edges (shown with dashed lines) do not follow a consistent pattern across the grid. This lack of alignment is what defines connectivity as irregular. This condition commonly arises when a 3D model created with quadrilaterals is converted into a triangular mesh for rendering or transmission, as the choice of diagonal for splitting each quad can be inconsistent.

This irregular pattern is less predictable and, therefore, more difficult for compression algorithms to encode efficiently, leading to larger file sizes. For example, traversing the mesh from left to right, the direction of the diagonal edges changes unpredictably. As described above, encoder 105 can be configured to identify this type of irregularity and regularizes it by flipping certain edges to create a uniform pattern. The regularization process can make the mesh data more compressible while storing the necessary information to reverse the process during decompression.

FIG. 2B illustrates the same portion of the mesh from FIG. 2A after the mesh has undergone a regularization process. In FIG. 2A, the connectivity is now regular, meaning the diagonal edges that split each quadrilateral follow a consistent, uniform pattern across the entire grid. Encoder 105 achieves this by identifying and flipping the specific diagonal edges in FIG. 2A (shown with dashed lines) that were causing irregularity. This process creates a more predictable structure, which is easier for compression algorithms to encode efficiently.

The resulting regularized mesh, as shown, has lower entropy due to its repeating patterns. For example, all diagonal edges (shown with solid and dashed lines) now run from the bottom-left vertex to the top-right vertex of each quad as shown in FIG. 2B. This uniformity allows prediction models used in compression to work more effectively, leading to a smaller compressed file size. After compressing this regularized mesh to create the compressed mesh 10, encoder 105 also generates the corresponding regularization data 20, which records the edge flips so that the original irregular connectivity can be perfectly restored during decompression.

In some implementations, regularization can be achieved by flipping the irregular edges (e.g., the dashed edges). The example regularization process can be configured to modify mesh connectivity such that each vertex is surrounded by six triangles if possible. In some implementations, each vertex can be surrounded by some number of triangles other than six (e.g., 4, 8, 12, 16, and the like). The instructions (e.g., regularization data 20) to restore the original connectivity can be included in the compressed mesh, so the decoder can restore the original mesh and provide lossless compression.

An example connectivity regularization algorithm is outlined as follows. In some implementations, the algorithm can be configured to detect an initial quad consisting of a pair of triangles, consider the quad regular, and propagate its diagonal orientation to neighbor quads by flipping their diagonals as needed, in a flood-fill manner. The following example connectivity regularization algorithm is just one example implementation. Other algorithms can be used and are within the scope of this disclosure.
1. Create a corner table from geometry
2. Mark all triangles unvisited
3. For each unvisited triangle:
   a. Get the next triangle A
   b. Continue to the next triangle if triangle A is far from being a right triangle
   c. Get the triangle B across the hypotenuse of triangle A
   d. Continue to the next triangle if triangle B is absent or visited
   e. Continue to the next triangle if triangle B is far from being a right triangle
   f Continue to the next triangle if quad AB is far from being a rectangle
   g. Mark quad AB as regular and push it into a queue
   h. For all unvisited quads in the queue (a quad is considered visited if any of its triangles are visited):
      (1) Obtain the next quad AB from the queue and mark it as visited
      (2) Flip the diagonal edge of quad AB if the quad is marked as irregular
      (3) For the four edges (top, left, down, right) of quad AB:
         (a) Get a pair of candidate neighbor quads across the edge
         (b) Discard a candidate neighbor quad if absent or visited
         (c) Choose a candidate neighbor quad CD or DE as shown in FIGS. 3A and 3B
         (d) Continue to the next quad if the chosen quad is far from parallelogram
         (e) Mark the chosen quad as regular in cases like those in FIG. 3A
         (f) Mark the chosen quad as irregular in cases like those in FIG. 3B
         (g) Push the chosen quad into the queue

While the breadth-first searches (BFS) start from root quads that are close to being rectangles, inside BFS the requirement can be relaxed, and the quads should only be close to being parallelograms. This can allow regularizing meshes where quad grids have areas where quads are rectangles but can gradually turn into non-rectangular parallelograms. At the same time, starting from a rectangular quad reduces the likelihood of latching to a quad grid in a wrong way, detecting quads spanning two halves of the original quads before triangularization.

FIG. 3A illustrates a portion of a mesh with regular connectivity according to at least one example implementation. FIG. 3B illustrates the portion of the mesh with irregular connectivity according to at least one example implementation. In FIG. 3A, CD (regular) is aligned with AB and in FIG. 3B, DE (irregular) is aligned with AB. Triangles A, B, C, D, E in FIGS. 3A and 3B have the same connectivity, therefore XYZ positions are used to choose either quad CD or DE. The algorithm considers the proximity of the positions of the top three vertices to positions predicted by extrapolating the vertical edges of quad AB.

FIG. 3A illustrates a portion of a mesh that exhibits regular connectivity, serving as an example of a local structure sought by the regularization algorithm. FIG. 3A shows a base quadrilateral AB (composed of two triangles A and B) and a neighboring quadrilateral CD that is aligned with it. This alignment is considered regular because the orientation of quad CD continues the grid-like pattern established by quad AB, which is a desirable property for efficient compression.

During the regularization process, an algorithm can identify a local configuration like this and mark quad CD as regular. For example, if the algorithm is expanding from quad AB, the algorithm can examine its neighbors to see if the neighbors continue the pattern. In this case, the algorithm determines that the arrangement with quad CD maintains a consistent, predictable flow. The algorithm uses vertex positions to make this determination, selecting the neighboring quad that best extrapolates the structure of quad AB. This regular pattern is contrasted with the irregular case shown in FIG. 3B, where the neighboring quad is not aligned.

FIG. 3B illustrates a portion of a mesh where the connectivity is considered irregular in the context of the regularization algorithm. FIG. 3B shows a base quadrilateral AB and a candidate neighboring quadrilateral. In this case, the selected neighbor is quad DE, which is not aligned with the grid-like structure of quad AB. The algorithm identifies this configuration as irregular because the orientation of quad DE breaks the predictable pattern that the regularization process aims to establish.

This determination is made by comparing the positions of vertices to an extrapolated pattern from the base quad AB. For example, the algorithm predicts where the next set of vertices should be to maintain a regular grid and finds that the vertices of quad DE do not match this prediction as well as the alternative (quad CD in FIG. 3A). In some implementations, the selected candidate quad is either marked as regular (quad CD in FIG. 3A) or the selected candidate quad is marked as irregular (quad DE in FIG. 3B).

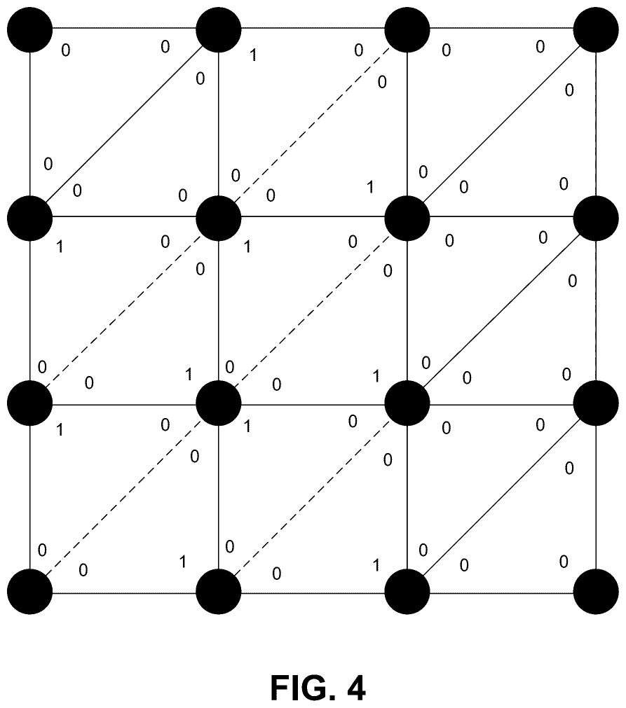

FIG. 4 illustrates a portion of a mesh with flipped edges represented as bits at each corner connectivity according to at least one example implementation. Connectivity regularization can be done in the geometry encoder (e.g., encoder 105) before vertex traversal begins. The outcome can be an updated indices array and an additional array of the same size, containing Booleans for each face corner, indicating whether an edge opposite to a corner was flipped. Therefore, for each flipped edge there may be two bits of value ‘1’. FIG. 4 shows an example of flipped edges array with bits at each corner. Some implementations can apply connectivity regularization to triangular meshes that meet the following criteria, which could be changed later without affecting the bitstream. Contain, for example, at least 90% of triangles participating in detected quads. Contain, for example, at least 50% long edges with L2 norm of 50 or more.

FIG. 4 illustrates how the regularization data (e.g., the record of flipped edges) can be represented. FIG. 4 shows a portion of a mesh where each quadrilateral is composed of two triangles. The data is stored as a boolean value, or bit, for each corner of every face, indicating whether the edge opposite that corner was flipped. For each edge that is flipped during the regularization process, the two corners opposite to it are marked with a ‘1’, while all other corners are marked with a ‘0’. This creates an array of bits that corresponds to the corners of the mesh.

The outcome of the regularization process is an updated set of vertex indices that define the new, regular connectivity, along with this array of boolean flags. This array of flipped edge bits constitutes the regularization data 20. Although it appears that two bits are stored for every flipped edge, this representation can provide a structured technique to record the changes. The decoder can use this information to reverse the flips, ensuring a lossless (or substantially lossless) reconstruction of the original mesh.

For example, a single quadrilateral in the middle of the grid that was determined to be irregular and its diagonal could have been flipped. The two triangles that make up this quad share the flipped diagonal edge. The corners of these two triangles that lie opposite this common edge would each be assigned a bit value of ‘1’. All other corners within this quad, and any corners in quads that were not modified, would have a bit value of ‘0’. This sparse array of bits can be efficiently encoded and transmitted alongside the compressed regularized mesh.

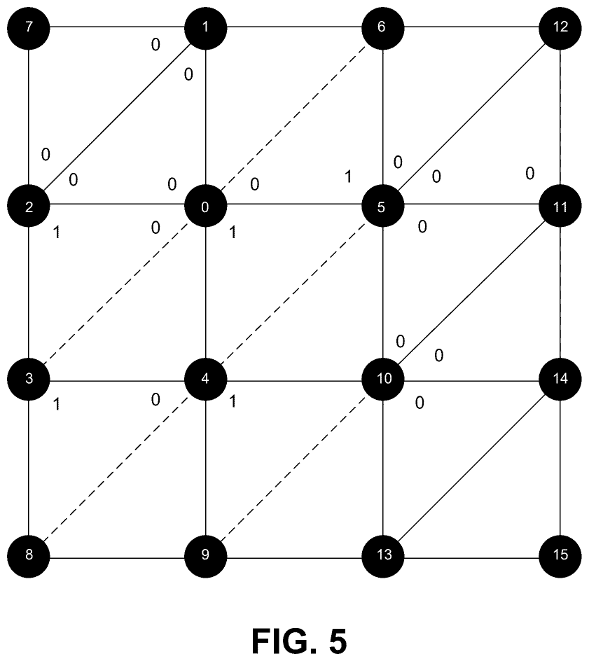

FIG. 5 illustrates the portion of the mesh with a subset of flipped edges represented as bits at each corner connectivity according to at least one example implementation. The information about flipped edges can be encoded in the bitstream for the decoder (e.g., decoder 110) to undo regularization by flipping those edges back to their original orientations. Therefore, the original connectivity can be restored, as expected of the lossless codec. The flipped edges array can be encoded in geometry encoder (e.g., encoder 105) during the traversal. The geometry decoder (e.g., decoder 110) can follow the same logic to decode the array of flipped edge bits.

FIG. 5 illustrates how a subset of the flipped edge bits, previously shown in FIG. 4, is encoded to create the regularization data 20. FIG. 5 can depict a portion of a mesh with vertices numbered according to their traversal order during the encoding process. Not all corner bits need to be explicitly encoded, as some information becomes redundant once neighboring bits are known. The encoder can leverage the mesh's structure to encode only the essential bits required to reconstruct the full set of flips.

This optimization can reduce the size of the regularization data. For instance, once an edge is known to be flipped (represented by a bit of ‘1’ at one of its opposing corners), the system can infer that the bits for the other two corners within the same triangle must be ‘0’. Similarly, the bit for the corner directly opposite the flipped edge in an adjacent, already-traversed triangle will be identical and does not need to be re-encoded. The figure shows that for a mesh portion with 54 corners, only 20 bits are actually encoded, conveying all the necessary information for lossless reconstruction.

For each visited triangle one bit per corner can be encoded, except for bits conveying redundant information that can be obtained from previously encoded corner bits. FIG. 5 shows vertices numbered according to their traversal order, and encoded corner bits. While there are 54 corners, only 20 corner bits are encoded, which are sufficient to convey connectivity regularization data. Keeping in mind that it can be sufficient to encode one bit per edge, and that each triangle can participate in no more than one quad, the following bits are not encoded. For example, bits opposite of visited faces can be known to be the same as the opposite corner bits. For example, bits next to bit 1 within the same triangle can be known to be 0. The resulting sequence of encoded bits and the corresponding vertices can be:

| | | | | | | | | | | | | | | | | | | | | |
|---|---|---|---|---|---|---|---|---|---|---|---|---|---|---|---|---|---|---|---|---|
| Vertex: | [0 | 1 | 2 | 0 | 2 | 0 | 0 | 5 | 1 | 2 | 4 | 3 | 4 | 5 | 10 | 5 | 11 | 5 | 10 | 10] |
| Bit: | [0 | 0 | 0 | 0 | 1 | 1 | 0 | 1 | 0 | 0 | 0 | 1 | 1 | 0 | 0 | 0 | 0 | 0 | 0 | 0] |

For example, during traversal, if the encoder encounters the quad formed by vertices {2, 0, 3, 4} and determines its diagonal edge (connecting vertices 2 and 4) was flipped, it encodes a ‘1’ for one of the opposing corners (e.g., the corner at vertex 3). The bit for the corner at vertex 0 can be inferred as ‘1’ as well, and the bits for corners at vertices 2 and 4 in the associated triangles are inferred as ‘0’. This selective encoding process ensures that the regularization data remains minimal while still enabling the decoder to perfectly reverse every edge flip.

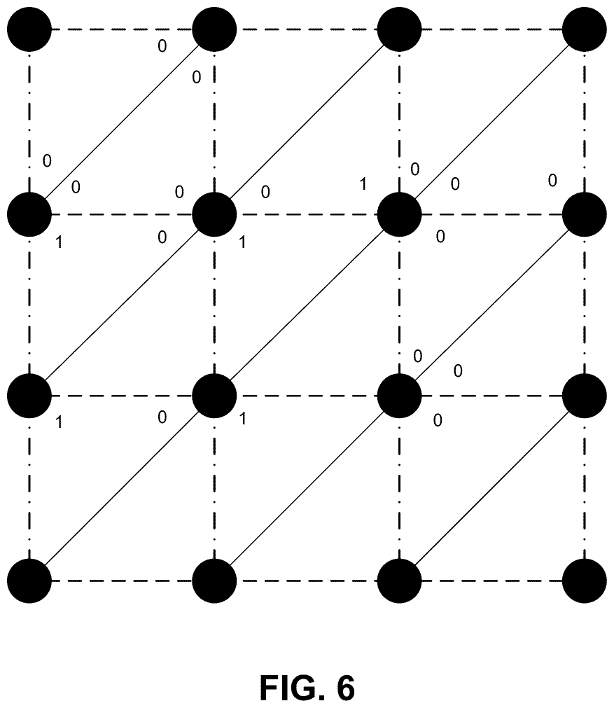

FIG. 6 illustrates the portion of the mesh with edge and corner identification according to at least one example implementation. To improve entropy coding, the bits can be encoded into five separate contexts based on edge orientation and regularity regions. Initially corners have unknown orientations, see underlined corner bits in FIG. 6. The first encountered bit ‘1’ indicates that an edge with diagonal orientation is found. The orientation of the following corners is computed from known corner orientations within the same triangle or from orientations of opposite corners in visited faces. FIG. 6 shows edges and corner bits color-coded according to their orientations.

FIG. 6 illustrates how the bitstream representing flipped edges can be optimized for entropy coding by dividing the bitstream into different contexts. The figure shows the mesh portion with edges and corners color-coded to represent different orientations: vertical, horizontal, and diagonal. This contextual information can help the entropy coder better predict the value of the next bit (which is typically ‘0’ for no flip, and ‘1’ for a flip), leading to more efficient compression of the regularization data.

The encoder can identify five distinct contexts: horizontal edges, vertical edges, regular diagonal edges, irregular (flipped) diagonal edges, and an unknown context for bits preceding the first flipped diagonal bit ‘1’ encountered in a region. As shown in FIG. 6, different line types are used to visualize these orientations. When encoding the flipped edge bits, the system places each bit into one of these contexts based on its edge orientation relative to the established regular grid. For example, a bit for a diagonal edge that conforms to the regular pattern is encoded in the regular diagonal context.

This separation can be effective because the probability of an edge being flipped varies significantly between contexts. For instance, bits in the regular diagonal context are more likely to be ‘0’, while bits in the “irregular diagonal” context are more likely to be ‘1’. By modeling these probabilities separately, the entropy coder can achieve a higher compression ratio for the regularization data. The figure's underlined bits represent corners with initially unknown orientations, which are resolved as the traversal progresses and neighboring edge orientations become known.

The first number of bits can have an unknown orientation, and they can be encoded into the unknown context. The following diagonal bits can be encoded either into regular or irregular context, depending on whether the previous diagonal bit was ‘0’ or ‘1’. Table 1 shows the context for the example in FIG. 6.

TABLE 1
Five contexts for encoding of the flipped edge bits

| Context | Typical Values | Example |
|---|---|---|
| Unknown | Mostly zeros | [0 0 0 0 1 0 0] |
| Horizontal | Mostly zeros | [0 0] |
| Vertical | Mostly zeros | [0 0 0 0] |
| Regular diagonal | Mostly zeros | [0 0] |
| Irregular diagonal (flipped) | Mostly zeros | [1 1 1 1 0] |

In some implementations, the encoder (e.g., encoder 105) can be configured to regularize mesh connectivity before vertex traversal begins. The flipped edges can be encoded during vertex traversal of the regularized mesh. The attributes can also be encoded for the regularized mesh.

A regularized mesh can refer to a triangular mesh that has been structurally modified from an original mesh to exhibit a more uniform and predictable connectivity pattern. Specifically, in the context of a mesh originating from quadrilaterals (quads), a regularized mesh is one where the diagonal edges that partition the quads into triangles follow a consistent orientation across a region of the mesh. For example, as shown in FIG. 2B, all diagonal edges may be oriented from the bottom-left vertex to the top-right vertex of their respective conceptual quads. This uniformity results in a topology where a majority of the interior vertices have a degree of six (i.e., they are connected to six other vertices), which is characteristic of a regular grid.

The state of being regularized can be achieved by an algorithmic process, such as the example connectivity regularization algorithm described above. This process identifies local quad structures and propagates a chosen diagonal orientation, flipping diagonals that deviate from this established pattern. Therefore, a regularized mesh is not defined by an absolute global perfection but rather by the outcome of a process that systematically reduces connectivity entropy. The resulting mesh is regularized in that its structure is dominated by predictable, repeating topological patterns that are highly amenable to compression algorithms, distinguishing it from an irregular mesh where such patterns are inconsistent or absent.

In some implementations, the decoder (e.g., decoder 110) can be configured to decode geometry with regularized connectivity. The flipped edges array can be decoded during the vertex traversal together with regularized connectivity and positions. After geometry and attributes are decoded, an original version of connectivity can be restored by flipping back the affected edges.

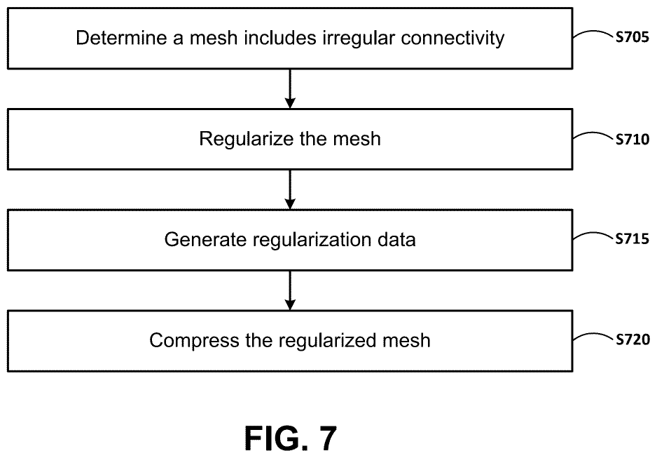

Example 1. FIG. 7 is a block diagram of a method for compressing a mesh according to an example implementation. As shown in FIG. 7, in step S705 determine a mesh includes irregular connectivity. This initial analysis is performed because the subsequent regularization steps are only beneficial for meshes that can be made more uniform. The system examines the input mesh's topology to identify patterns that deviate from a regular, grid-like structure, such as those that often result from the inconsistent triangulation of quadrilaterals.

This determination can be based on several criteria. For example, the algorithm can count the number of vertices with a degree other than six, which is typical for regular grid structures. The algorithm could also analyze the orientation of diagonal edges to detect inconsistencies or chaotic patterns. As an example, the mesh portion shown in FIG. 2A would be identified as having irregular connectivity because the diagonal edges do not follow a consistent direction. If the mesh is found to have sufficient irregularity, the process continues to step S710 to regularize it; otherwise, the mesh may be compressed directly without modification.

Original irregular connectivity can refer to the initial topological state of a triangular mesh, prior to any regularization, that is characterized by inconsistent or unpredictable patterns in how its vertices are connected. This condition is most common in meshes derived from the triangulation of quadrilateral (quad) grids, where the diagonal edge chosen to split each quad into two triangles does not follow a uniform rule across the mesh. As illustrated in FIG. 2A, this results in a mesh where the orientation of diagonal edges can appear random or haphazard, breaking the predictable grid-like structure that is optimal for compression algorithms. The term original indicates that this is the connectivity of the input mesh 5 as presented to the encoder, and irregular indicates the lack of a consistent, repeating pattern in the local topology.

This irregularity is quantitatively reflected in several ways: a higher variability in vertex degrees (e.g., vertices connected to four, five, seven, or eight neighbors, rather than the consistent six of a regular grid), and a higher entropy when traversing the mesh's connectivity graph. From a predictive compression standpoint, this means that the local neighborhood of a vertex cannot be reliably predicted from its neighbors, reducing the efficiency of compression. The system is designed to identify this original irregular connectivity, transform it into a regularized state for efficient compression, and then losslessly restore it during decompression, ensuring the reconstructed mesh is identical to the original.

In step S710 regularize the mesh. After determining that the mesh has irregular connectivity, the process proceeds to step S710, where the mesh is regularized. In this step, the encoder can modify the mesh's connectivity by identifying and flipping specific diagonal edges that cause irregularities. The goal can be to transform the unpredictable patterns into a uniform, grid-like structure, as this regularized form is more efficiently compressed. The regularization algorithm typically propagates a consistent diagonal orientation across the mesh in a flood-fill manner, flipping edges as needed to conform to the established pattern.

For example, the encoder can analyze the mesh in FIG. 2A, identify the diagonal edges that are misaligned with their neighbors, and flip them. This transforms the connectivity into the regularized version shown in FIG. 2B, where all diagonals now follow a consistent direction (e.g., from bottom-left to top-right within each virtual quad). This modification creates a mesh with lower entropy, which is then passed to subsequent steps for generating regularization data and for compression.

A mesh compression algorithm, particularly one focusing on connectivity, typically works by identifying and exploiting the predictable structure of the mesh. The algorithm traverses the mesh, vertex by vertex, and encodes the connectivity information (e.g., how vertices are linked to form edges and triangles) using predictive coding. For a given vertex, instead of explicitly listing all its neighbors, the algorithm predicts the local connectivity based on the already-processed parts of the mesh. For regular, grid-like meshes, these predictions are highly accurate, requiring very little data to correct the occasional error. This process effectively converts the complex graph of connections into a compact sequence of symbols that can be efficiently compressed using entropy coding techniques like arithmetic or Huffman coding.

Attribute data, such as vertex positions, normals, and texture coordinates, is compressed in a similar predictive fashion. Once the connectivity is known, the algorithm can predict the position of the next vertex by extrapolating from its already-encoded neighbors. For instance, in a smooth surface, a new vertex's position is likely to be the average of its neighbors' positions. The algorithm only needs to encode the small difference, or “delta,” between the predicted position and the actual position. This delta value is typically small, and a stream of such small values can be compressed very efficiently, significantly reducing the overall file size of the 3D model.

For example, consider compressing a simple triangular grid representing a flat plane. The algorithm can start at a corner vertex and encodes its position. It then moves to an adjacent vertex. Based on the connectivity traversal, it predicts the second vertex's position will be one unit to the right. If this prediction is correct, it stores a minimal amount of data confirming this. It continues this process, predicting each new vertex's position and connectivity based on the established grid pattern. The resulting compressed file consists of the initial vertex data followed by a highly compact stream of minor corrections and confirmations, which is far smaller than a file listing the absolute coordinates and full connectivity for every single vertex in the mesh.

Compressing a mesh can refer to the process of reducing its digital file size by analyzing its data for patterns and predictability and then encoding that data using algorithms that exploit these properties. This may involve techniques such as predictive coding, where the value of a data point is predicted from its neighbors, and entropy coding, which assigns shorter codes to more frequent symbols, to represent the mesh information with fewer bits. Compressing a mesh can include applying a set of data encoding operations to its constituent data, such as vertex positions and connectivity information, to create a more compact digital representation. This process transforms the mesh data into a format that requires fewer bits for storage or transmission while retaining the information necessary for its reconstruction. Compressing a mesh can include algorithmically encoding its geometric and attribute data into a smaller format by removing statistical redundancy, for the purpose of more efficient storage and transmission.

In step S715 generate regularization data. Following the regularization of the mesh, the process moves to step S715, where regularization data is generated. This data can serve as a record of all the modifications made to the original mesh's connectivity during step S710. Specifically, the encoder can log which diagonal edges were flipped to create the uniform, regularized structure. This information can be used for ensuring the compression process is lossless (or substantially lossless), as the information can allow the decoder to reverse the changes and restore the original mesh connectivity. The regularization data can be stored in an efficient format, such as an array of bits, to minimize its impact on the final file size.

For example, if the encoder flips several edges in the mesh from FIG. 2A to produce the regularized version in FIG. 2B, the regularization data can identify each of those flipped edges. As shown in FIG. 4, this can be represented as a set of boolean flags corresponding to the corners of the mesh faces. This data is then passed, along with the regularized mesh, to the final compression step.

In step S720 compress the regularized mesh and the regularization data. Finally, the encoder can compress the regularized mesh and the regularization data. After the mesh has been structurally modified for better predictability (S710) and the record of these changes has been saved (S715), a compression algorithm can be applied to one or both datasets. The regularized mesh can be compressed to create the compressed mesh 10, while the regularization data is separately encoded to create the regularization data 20. Because the regularized mesh has lower entropy, the compression algorithm can achieve a higher compression ratio, resulting in a smaller final file size.

For example, the regularized mesh shown in FIG. 2B can be encoded using techniques that take advantage of its predictable grid structure, producing the compressed mesh 10. Simultaneously, the bitstream representing the flipped edges (as detailed in FIG. 4 and FIG. 5) can be entropy-coded to generate the compact regularization data 20. Both of these outputs can be ready for storage or transmission, to be used together by the decoder to perfectly reconstruct the original mesh.

A regularized mesh can refer to a triangular mesh that has been structurally modified from an original mesh to exhibit a more uniform and predictable connectivity pattern. Specifically, in the context of a mesh originating from quadrilaterals (quads), a regularized mesh is one where the diagonal edges that partition the quads into triangles follow a consistent orientation across a region of the mesh. For example, as shown in FIG. 2B, all diagonal edges may be oriented from the bottom-left vertex to the top-right vertex of their respective conceptual quads. This uniformity results in a topology where a majority of the interior vertices have a degree of six (i.e., they are connected to six other vertices), which is characteristic of a regular grid. The state of being regularized can be achieved by an algorithmic process, such as the example connectivity regularization algorithm described above. This process identifies local quad structures and propagates a chosen diagonal orientation, flipping diagonals that deviate from this established pattern. Therefore, a regularized mesh may not be defined by an absolute global perfection but rather by the outcome of a process that systematically reduces connectivity entropy. The resulting mesh is regularized in that its structure is dominated by predictable, repeating topological patterns that are highly amenable to compression algorithms, distinguishing it from an irregular mesh where such patterns are inconsistent or absent.

The state of being regularized can be the result of an algorithmic process that identifies and modifies inconsistent connectivity. The process can identify local quad structures and propagates a preferred diagonal orientation across the mesh, for example, by flipping diagonals that deviate from the established pattern. Therefore, a regularized mesh can be distinguished from an irregular one not necessarily by absolute global perfection, but by having its structure dominated by repeating topological patterns. For example, in a regularized triangular grid, a majority of interior vertices will have a degree of six (connected to six other vertices), a characteristic that is often disrupted in irregular meshes.

An example of this concept is illustrated in FIGS. 2A and 2B. FIG. 2A shows a mesh with irregular connectivity, where the diagonal edges splitting the conceptual quads are oriented inconsistently. An encoding process would modify this mesh by performing edge flips on the misaligned diagonals. The result is the regularized mesh shown in FIG. 2B, where all diagonal edges now follow a uniform pattern (e.g., from bottom-left to top-right). This regularized mesh has a more predictable structure and can be compressed more efficiently than its irregular counterpart.

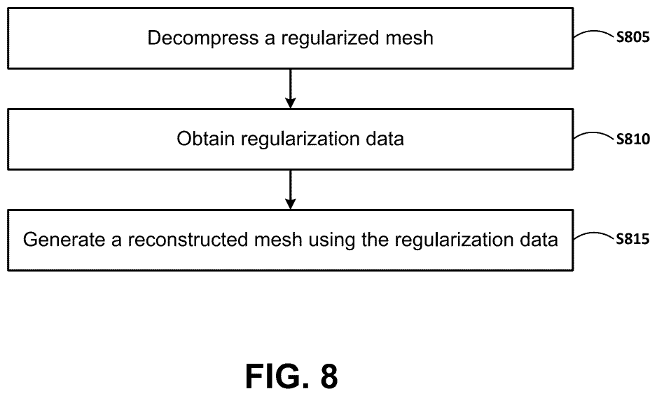

Example 2. FIG. 8 is a block diagram of a method of decompressing a compressed mesh according to an example implementation. As shown in FIG. 8, in step S805 decompress a regularized mesh. The decoder 110 can receive the compressed mesh 10, which contains the geometric and attribute data for the regularized version of the original mesh. This version can have a uniform connectivity structure that makes it highly compressible. The decoder applies a decompression algorithm to this data to reconstruct the full, uncompressed regularized mesh.

For example, if the compressed mesh 10 represents the regularized grid shown in FIG. 2B, then after step S805, the decoder can have a complete in-memory representation of that regularized mesh. This mesh can have a uniform, predictable connectivity but does not yet match the original input mesh 5 because it lacks the original irregular connectivity. This intermediate mesh serves as the foundation for the subsequent steps, which will use the regularization data to restore the original structure.

Original irregular connectivity can refer to the initial topological state of a triangular mesh, prior to any regularization, that is characterized by inconsistent or unpredictable patterns in how its vertices are connected. This condition is most common in meshes derived from the triangulation of quadrilateral (quad) grids, where the diagonal edge chosen to split each quad into two triangles does not follow a uniform rule across the mesh. As illustrated in FIG. 2A, this results in a mesh where the orientation of diagonal edges can appear random or haphazard, breaking the predictable grid-like structure that is optimal for compression algorithms. The term original can signify that this is the connectivity of the input mesh 5 as presented to the encoder, and irregular can denote the lack of a consistent, repeating pattern in the local topology.

This irregularity is quantitatively reflected in several ways: a higher variability in vertex degrees (e.g., vertices connected to four, five, seven, or eight neighbors, rather than the consistent six of a regular grid), and a higher entropy when traversing the mesh's connectivity graph. From a predictive compression standpoint, this means that the local neighborhood of a vertex cannot be reliably predicted from its neighbors, reducing the efficiency of compression. The system is designed to identify this original irregular connectivity, transform it into a regularized state for efficient compression, and then losslessly restore it during decompression, ensuring the reconstructed mesh is identical to the original.

In step S810 obtain regularization data. After the regularized mesh is reconstructed (e.g., decompressed), the process continues to step S810, where the regularization data is obtained. This data, generated by the encoder 105 and transmitted alongside the compressed mesh 10, can contain the information needed to reverse the regularization process. The data can be used as a set of instructions, identifying a diagonal edge that was flipped during the encoding stage to create the uniform connectivity structure of the regularized mesh. The decoder 110 accesses this data, which is typically a compact bitstream, to prepare for the final step of reconstruction. For example, the regularization data 20 can include a series of bits indicating ‘1’ for a flipped edge and ‘0’ for an unchanged one, as depicted in FIG. 4. The decoder can read this information, which might correspond to the modifications that transformed the irregular mesh of FIG. 2A into the regularized version of FIG. 2B. This data can be used to ensure a lossless (or substantially lossless) process, as without it, the decoder would have difficulty restoring the original, irregular connectivity of the mesh.

In step S815 generate a reconstructed mesh using the regularization data. The decoder can generate the reconstructed mesh using the regularization data. This is the last step in the decompression process, where the decoder can apply the information obtained in step S810 to the decompressed mesh from step S805. The process can involve performing inverse edge flips on the decompressed regularized mesh. Each edge identified in the regularization data as having been flipped during encoding can be flipped back to its original orientation. This action systematically reintroduces the irregular connectivity that was initially removed to improve compression efficiency.

An inverse edge flip can be the operation performed by the decoder to reverse a corresponding edge flip that occurred during the encoding process. An edge flip is a common topological operation in mesh processing where a single edge shared by two adjacent triangles is removed and replaced by a new edge connecting the two previously unconnected vertices of the quadrilateral formed by the two triangles. This effectively changes which pair of vertices in the quadrilateral is connected by a diagonal. The inverse of this operation is simply performing the same edge flip operation again on the same edge, which restores the original connectivity. For example, if an edge connecting vertices A and C was flipped to connect vertices B and D, an inverse edge flip on the new B-D edge would remove it and re-establish the A-C edge.

The inverse edge flip can be the mechanism for restoring the original irregular connectivity of the mesh. The regularization data 20 can include a set of instructions, effectively a list of which edges were flipped by the encoder. The decoder, after decompressing the regularized mesh, reads this data and applies an inverse edge flip to each identified edge. As described in claim 18, this process systematically undoes the modifications made during regularization, reintroducing the original irregularities and ensuring that the final reconstructed mesh 15 is a lossless, bit-for-bit identical copy of the original input mesh 5.

For example, using the regularization data that specifies which edges were flipped to transform FIG. 2A into FIG. 2B, the decoder can flip those same edges on the now-decompressed version of FIG. 2B. This reversal restores the original irregular connectivity, resulting in a mesh that is identical to the one shown in FIG. 2A. The final output is the reconstructed mesh 15, which can be a lossless (or substantially lossless) copy of the original input mesh 5.

Example 3. The method of Example 1, wherein regularizing the mesh can include identifying an edge with irregular connectivity and modifying the mesh by regularizing the identified edge.

Example 4. The method of Example 3, wherein modifying the mesh can include rotating a triangle associated with the identified edge. Rotating a triangle can refer to a geometric transformation that reorients a triangle within a fixed set of vertices. In the context of a triangular mesh, specifically one formed by triangulating quadrilaterals, this concept is ambiguous. Rotating a triangle can be an edge flip, which can modify the connectivity between two adjacent triangles that share a common edge and together form a quadrilateral. This operation can include reconfiguring the pair by removing their shared edge and inserting the alternative diagonal within the quadrilateral.

For example, consider a quadrilateral with vertices labeled A, B, C, and D in clockwise order. If two triangles are defined by vertices (A, B, C) and (A, C, D), they share the diagonal edge AC. Rotating a triangle or an edge flip can remove edge AC and create a new edge, BD. The mesh would then be composed of two new triangles, (B, C, D) and (B, D, A). While the vertices remain the same, the connectivity has changed.

Example 5. The method of Example 3, wherein the regularization data can identify a quad associated with the identified edge and the quad can be formed by two adjacent triangles that share the identified edge.

Example 6. The method of Example 1, wherein a mesh with irregular connectivity can include an edge having a direction that is inconsistent with surrounding edges.

Example 7. The method of Example 1, can further include determining a percentage of triangles in the mesh, wherein the determining of whether the mesh includes irregular connectivity can further include determining the percentage of triangles meets a criteria.

Example 8. The method of Example 1, can further include identifying a geometric property associated with the mesh, wherein the determining the mesh includes irregular connectivity can further include determining the geometric property meets a criteria.

Example 9. The method of Example 2, wherein generating the reconstructed mesh can include modifying the decompressed mesh by rotating a triangle associated with an edge identified using the regularization data.

Example 10. The method of Example 2, wherein generating the reconstructed mesh can include identifying an edge flip instruction in the regularization data and applying an inverse edge flip to the decompressed mesh. In the context of the decompression process an edge flip instruction can refer to the specific information within the regularization data that directs the decoder to perform an inverse edge flip on a particular edge of the decompressed, regularized mesh. The regularization data can be a record of which edges were flipped by the encoder to create a more uniform mesh (e.g., stored as a list, bitmask, or array of Booleans). The term instruction characterizes this data from the decoder's perspective. For example, an instruction can be a command to reverse a specific topological modification. By executing these instructions, the decoder can restore the original, irregular connectivity of the mesh.

For example, consider the decoder has just decompressed a mesh into the regularized form shown in FIG. 2B. The decoder can then obtain the regularization data. This data contains edge flip instructions identifying the five specific diagonal edges that were originally flipped by the encoder. For each of these five edges, the decoder follows the instruction and performs an inverse edge flip. This operation removes the regularized diagonal and re-inserts the original, irregular one. After executing all five instructions, the mesh is transformed back into the state shown in FIG. 2A, completing the lossless reconstruction.

An inverse edge flip can be an operation performed by the decoder to reverse a corresponding edge flip that occurred during encoding and is the mechanism for restoring the original irregular connectivity. An inverse edge flip can be the topological operation performed by the decoder to reverse a corresponding edge flip that occurred during the encoding process. An edge flip is an operation in mesh processing where an edge shared by two adjacent triangles is removed and replaced by the alternative diagonal of the quadrilateral formed by the two triangles. The inverse of this operation is simply performing the same edge flip operation again on the newly created edge, which restores the original connectivity. For example, if an edge connecting vertices A and C was flipped to connect vertices B and D, an inverse edge flip on the new B-D edge would remove it and re-establish the A-C edge.

The inverse edge flip can be the mechanism for restoring the original irregular connectivity of the mesh during decompression. The regularization data provides a list of instructions indicating which edges were flipped by the encoder. The decoder, after decompressing the regularized mesh, reads this data and applies an inverse edge flip to each identified edge. This process systematically undoes the modifications made during regularization, reintroducing the original irregularities and ensuring that the final reconstructed mesh is a lossless, bit-for-bit identical copy of the original input mesh.

Example 11. The method of Example 2, wherein the array of bits can be a subset of all possible bits required to describe edge flips, non-included bits can be inferred based on a traversal order and relationships with included bits, and obtaining the regularization data can include decoding the array of bits using a plurality of entropy coding contexts, wherein each context can correspond to an orientation of an edge associated with a bit.

Example 12. The method of Example 2, wherein the regularization data can include an array of boolean values and each boolean value can indicate whether an edge opposite a corresponding face corner was flipped.

Example 13. The method of Example 2, wherein obtaining the regularization data can further include decoding a bitstream representing the regularization data using a plurality of entropy coding contexts, and a context can correspond to a different orientation of edges in the regularized mesh.

Example 14. A method can include any combination of one or more of Example 1 to Example 13.

Example 15. A non-transitory computer-readable storage medium comprising instructions stored thereon that, when executed by at least one processor, are configured to cause a computing system to perform the method of any of Examples 1-14.

Example 16. An apparatus comprising means for performing the method of any of Examples 1-14.

Example 17. An apparatus comprising at least one processor and at least one memory including computer program code, the at least one memory and the computer program code configured to, with the at least one processor, cause the apparatus at least to perform the method of any of Examples 1-14.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

What is claimed is:

1. A method comprising:
determining a mesh includes irregular connectivity;
in response to determining the mesh includes irregular connectivity,
regularizing the mesh, and
generating regularization data; and
compressing the regularized mesh and the regularization data.

2. The method of claim 1, wherein regularizing the mesh includes:
identifying an edge with irregular connectivity; and
modifying the mesh by regularizing the identified edge.

3. The method of claim 2, wherein modifying the mesh includes rotating a triangle associated with the identified edge.

4. The method of claim 2, wherein
the regularization data identifies a quad associated with the identified edge, and
the quad being formed by two adjacent triangles that share the identified edge.

5. The method of claim 1, wherein a mesh with irregular connectivity includes an edge having a direction that is inconsistent with surrounding edges.

6. The method of claim 1, further comprising:
determining a percentage of triangles in the mesh, wherein
the determining that the mesh includes irregular connectivity further includes determining the percentage of triangles meets a criteria.

7. The method of claim 1, further comprising:
identifying a geometric property associated with the mesh, wherein
the determining that the mesh includes irregular connectivity further includes determining the geometric property meets a criteria.

8. A non-transitory computer-readable storage medium comprising instructions stored thereon that, when executed by a processor, are configured to cause a computing system to:
determine a mesh includes irregular connectivity;
in response to determining the mesh includes irregular connectivity,
regularize the mesh, and
generate regularization data; and
compress the regularized mesh and the regularization data.

9. The non-transitory computer-readable storage medium of claim 8, wherein regularizing the mesh includes:
identifying an edge with irregular connectivity; and
modifying the mesh by regularizing the identified edge.

10. The non-transitory computer-readable storage medium of claim 9, wherein modifying the mesh includes rotating a triangle associated with the identified edge.

11. The non-transitory computer-readable storage medium of claim 9, wherein
the regularization data identifies a quad associated with the identified edge, and
the quad being formed by two adjacent triangles that share the identified edge.

12. The non-transitory computer-readable storage medium of claim 8, wherein a mesh with irregular connectivity includes an edge having a direction that is inconsistent with surrounding edges.

13. The non-transitory computer-readable storage medium of claim 8, wherein the instructions further include determining a percentage of triangles in the mesh, wherein
the determining that the mesh includes irregular connectivity further includes determining the percentage of triangles meets a criteria.

14. The non-transitory computer-readable storage medium of claim 8, wherein the instructions further include identifying a geometric property associated with the mesh, wherein
the determining that the mesh includes irregular connectivity further includes determining the geometric property meets a criteria.

15. A method comprising:
decompressing a regularized mesh;
obtaining regularization data; and
generating a reconstructed mesh based on the regularized mesh using the regularization data.

16. The method of claim 15, wherein obtaining the regularization data further includes:
decoding a bitstream representing the regularization data using a plurality of entropy coding contexts, wherein a context corresponds to a different orientation of edges in the regularized mesh.

17. The method of claim 15, wherein generating the reconstructed mesh includes modifying the decompressed mesh by rotating a triangle associated with an edge identified using the regularization data.

18. The method of claim 15, wherein generating the reconstructed mesh includes identifying an edge flip instruction in the regularization data and applying an inverse edge flip to the decompressed mesh.

19. The method of claim 15, wherein
an array of bits is a subset of all possible bits required to describe edge flips,
non-included bits are inferred based on a traversal order and relationships with included bits, and
obtaining the regularization data includes decoding the array of bits using a plurality of entropy coding contexts, wherein each context corresponds to an orientation of an edge associated with a bit.

20. The method of claim 15, wherein
the regularization data includes an array of Boolean values, and
a Boolean value indicates whether an edge opposite a corresponding face corner was flipped.
